(19) United States
(12) Patent Application Publication
(10) Pub. No.: US 2023/0267688 A1
(43) Pub. Date: Aug. 24, 2023

(54) GENERATING A VIRTUAL WORLD IN A VIRTUAL UNIVERSE

(71) Applicant: Meta Platforms Technologies, LLC, Menlo Park, CA (US)

(72) Inventors: Mina Maher Shawky Abouseif, Clyde Hill, WA (US); Oludare Victor Obasanjo, Renton, WA (US); Michael Philip Arcuri, Seattle, WA (US); Rachel Levkovich, San Jose, CA (US); Jeffrey Lin, Encino, CA (US); Katherine Ward, Montclair, NJ (US); Joshua Ryan Williams, Seattle, WA (US); Jonathan Larsen Eide, Hillsborough, CA (US); Austen McRae, Coronado, CA (US); Philip Woods, Reno, NV (US)

(21) Appl. No.: 17/992,776

(22) Filed: Nov. 22, 2022

Related U.S. Application Data
(60) Provisional application No. 63/333,509, filed on Apr. 21, 2022.

(51) Int. Cl. G06T 19/00; G06Q 30/0601

(52) U.S. Cl. CPC G06T 19/00; G06Q 30/0601; G06Q 2220/18

(57) ABSTRACT

Methods, systems, and storage media for generating a virtual world in a virtual universe are disclosed. Exemplary implementations may: generate virtual objects comprising object representations in a virtual world of a virtual universe; generate avatars comprising user representations of themselves in the virtual world; generate spatial containers within the virtual world; and process transactions regarding the virtual objects between the avatars based on evaluations of rights sets associated with the virtual objects.

### CROSS REFERENCE TO RELATED APPLICATIONS

This application claims priority under 35 U.S.C. § 119(e) to U.S. Provisional Application No. 63/333,509 filed Apr. 21, 2022, the disclosures of which applications are incorporated by reference herein, in their entirety, for all purposes.

### TECHNICAL FIELD

The present disclosure generally relates to providing a metaverse and/or its constituent virtual universes and/or virtual worlds and more particularly to generating a virtual world in a virtual universe.

### BACKGROUND

A metaverse may include many virtual universes, each of which include multiple virtual worlds. Virtual worlds may be three-dimensional and inhabited by avatars, which may or may not be associated with human users. Avatars may traverse a given virtual world and interact with virtual objects therein.

### BRIEF SUMMARY

The subject disclosure provides for systems and methods for providing a metaverse and/or its constituent virtual universes and/or virtual worlds. A user is allowed to create virtual objects, spaces, and/or worlds within one or more virtual universes. For example, the user may create a virtual object and manage how it is used, modified, and/or transacted. As another example, the user may create a virtual space as well as community guidelines for that virtual space that relate to behavior and expressions of avatars that enter that virtual space.

One aspect of the present disclosure relates to a method for generating a virtual world in a virtual universe. The method may include generating virtual objects including object representations in a virtual world of a virtual universe. The method may include generating avatars including user representations of themselves in the virtual world. The method may include generating spatial containers within the virtual world. The method may include processing transactions regarding the virtual objects between the avatars based on evaluations of rights sets associated with the virtual objects.

Another aspect of the present disclosure relates to a system configured for generating a virtual world in a virtual universe. The system may include one or more hardware processors configured by machine-readable instructions. The processor(s) may be configured to generate virtual objects including object representations in a virtual world of a virtual universe. The processor(s) may be configured to generate avatars including user representations of themselves in the virtual world. A given avatar may be associated with a specific user account in a centrally managed system. The processor(s) may be configured to generate spatial containers within the virtual world. The spatial containers may include multiple virtual objects. The processor(s) may be configured to process transactions regarding the virtual objects between the avatars based on evaluations of rights sets associated with the virtual objects. A given rights set may include limited units of an ability to use, modify, and/or transact a virtual object.

Yet another aspect of the present disclosure relates to a non-transient computer-readable storage medium having instructions embodied thereon, the instructions being executable by one or more processors to perform a method for generating a virtual world in a virtual universe. The method may include generating virtual objects including object representations in a virtual world of a virtual universe. A given virtual object may not be inhabited by avatars. The method may include generating avatars including user representations of themselves in the virtual world. A given avatar may be associated with a specific user account in a centrally managed system. The method may include generating spatial containers within the virtual world. The spatial containers may include multiple virtual objects. A given spatial container may be inhabited by avatars. The method may include processing transactions regarding the virtual objects between the avatars based on evaluations of rights sets associated with the virtual objects. A given rights set may include limited units of an ability to use, modify, and/or transact a virtual object.

Still another aspect of the present disclosure relates to a system configured for generating a virtual world in a virtual universe. The system may include means for generating virtual objects including object representations in a virtual world of a virtual universe. The system may include means for generating avatars including user representations of themselves in the virtual world. The system may include means for generating spatial containers within the virtual world. The system may include means for processing transactions regarding the virtual objects between the avatars based on evaluations of rights sets associated with the virtual objects.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a metaverse in which multiple virtual worlds are provided within multiple virtual universes, according to certain aspects of the disclosure.

FIG. 2 illustrates a system configured for providing a metaverse and/or its constituent virtual universes and/or virtual worlds, in accordance with one or more implementations.

FIG. 3 illustrates an example flow diagram for generating a virtual world in a virtual universe, according to certain aspects of the disclosure.

FIG. 4 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

There currently lacks an ability to move avatars and/or virtual objects and to transact across virtual worlds within different virtual universes. Furthermore, creators lack an ability to define community guidelines and/or standards associated with virtual objects and/or virtual spaces (i.e., spatial containers) associated with different virtual worlds and/or virtual universes.

The subject disclosure provides for systems and methods for providing a metaverse and/or its constituent virtual universes and/or virtual worlds. A user is allowed to create community guidelines for virtual objects, spaces, and/or worlds within one or more virtual universes. The community guidelines are generally rooted in principles of user safety and other benefits to the community. For example, the user may create a virtual object and control how it is used, modified, and/or transacted. As another example, the user may create a virtual space and control which avatars may enter and which behaviors and expressions are allowed within the virtual space.

Implementations described herein address the aforementioned shortcomings and other shortcomings by giving people access to primitives (e.g., associated with virtual objects and/or virtual spaces) and a system for how they can link, nest, and merge those primitives, declare the community guidelines that affect the primitives, and then name resulting complex virtual spaces. By allowing people to name their virtual spaces, multiple aggregations may naturally form, such as homeowners’ associations, neighborhoods, malls, cities, countries, etc., each with varying levels of self-declared guidelines, standards, and/or economic contracts.

A metaverse may be described as an evolution of the current internet. As such, the metaverse may need to match the economic opportunity provided to billions of people by the internet. A set of foundational building blocks are provided, in accordance with some implementations, that can satisfy both existing business models that people want to transpose into the metaverse and enable new ones that can only exist there.

Exemplary implementations may enable creators to build destinations and define and/or enable them to set metaverse behavior standards through community creation and curation. Given these may be time consuming and difficult tasks, creators may be enabled to monetize their time and efforts. In some implementations, an economic model expands beyond a given virtual world (or even a given virtual universe) to include third-party experiences. To ensure the economic model scales to meet the needs of the metaverse, both service-based and goods-based transactions may be supported. Within the metaverse, people may be able to buy goods from each other as well as be able to pay for services performed by others.

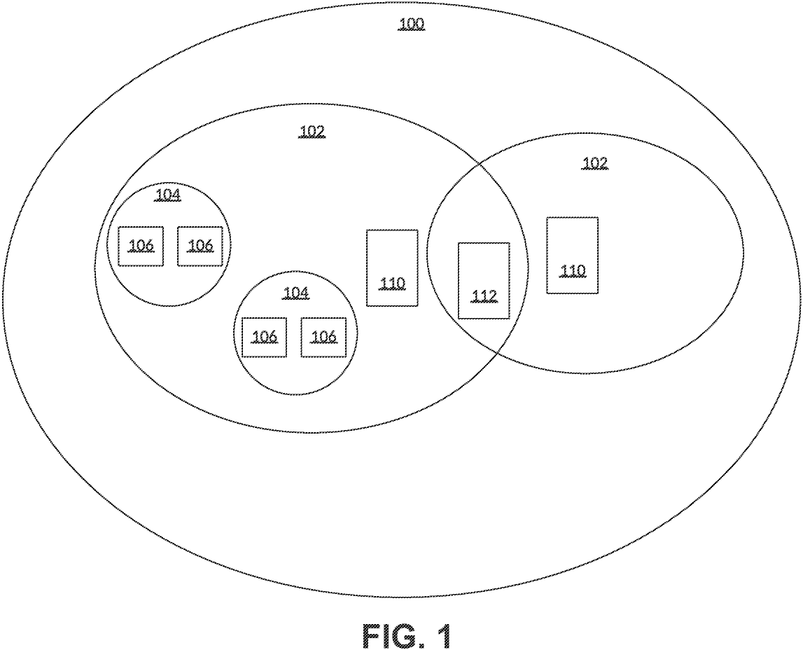

FIG. 1 illustrates an example architecture of a metaverse 100 in which multiple virtual worlds are provided within multiple virtual universes, according to certain aspects of the disclosure. For example, the metaverse 100 may include a collection of two or more virtual universes 102 connected via interoperable protocols and formats. A given virtual universe 102 may each include multiple virtual worlds 104.

In some implementations, a given universe 102 may be provided by a single entity (e.g., a company or organization). Different entities may provide competing universes 102, each having their own payment infrastructure, availability of goods and services, tooling, etc. A given universe may span all of the associated entity’s properties (e.g., virtual worlds, applications, etc.). Users, via their respective avatars, may travel across virtual universes by way of teleportation. Travel may not be possible between certain virtual universes 102.

Virtual worlds 104 may be root spaces that may contain nested spaces within them. Deep linking and/or teleportation may be provided into a specific space within a given virtual world 104. Users may enter a space of the given virtual world 104 and then discover other spaces in the given virtual world 104. Community guidelines and/or standards models, physics, and/or other attributes may be defined at the virtual world layer.

Virtual spaces 106 (e.g., spatial containers, virtual spaces, etc.) within individual virtual worlds 104 may be composed of multiple virtual objects and may be inhabited by avatars. An owner of a given virtual space 106 may manage one or more of access (e.g., who is allowed to enter), personal expression (e.g., what avatar representations are allowed), social norms (e.g., what behaviors are allowed), and/or other aspects associated with the given virtual space 106. For example, a user may create a virtual space 106 that may function as the user’s personal space. The user may be the owner of that virtual space 106 and may specify which other users may enter the virtual space, which avatar representations are allowed or not allowed (e.g., the user may ban green avatars), and which behaviors are not allowed (e.g., the user may ban specific transactions). In contrast to a virtual space 106, in some examples, universes within a broader metaverse may be prohibited from preventing users from traveling between universes. This may enable broad interoperability between universes in the metaverse. Individual virtual spaces 106 may be the smallest unit of interactive experience within corresponding virtual worlds 104. Some virtual spaces 106 may have a membership such that a person can belong to a specific virtual space 106, which grants the person additional privileges relative to non-members. For example, a virtual space 106 may be labeled as a user’s apartment or home, which may alter where the user teleports when traveling to the virtual space 106.

Virtual spaces 106 may be a special object in that they can be inhabited by avatars. As such, virtual spaces 106 may be pointed to by entitlements, and may be sold, transferred, licensed, etc. Virtual spaces 106 may have rights sets associated with them. Virtual spaces 106 may be nested to form more complex spaces. For example, a given virtual world 104 may host several nested virtual spaces 106.

An entitlement may contain one or more of a pointer to a virtual object, a pointer to an identity, a pointer to a rights set, and/or other pointers. In some implementations, several entitlements may point to the same virtual object, creating shared ownership of virtual objects. Examples of rights that may be granted and revoked as part of an entitlement contract may include whether or not the holder of the entitlement is allowed to sell, trade, change, compose, decompose, etc. the virtual object pointed to by the entitlement. An entitlement contract may capture revenue share requirements for future transactions involving the virtual object.

A given entitlement may have one or more properties such as whether the given entitlement is consumable (e.g., includes multi-use items), is durable, is subscription, is expirable, is geographically restricted, is exportable (e.g., as an NFT), is agreement, is verified (e.g., has some proof of authenticity), requires attribution (a condition on “can be traded”), generates income (e.g., revenue share income to multiple people with minimum and maximum), and/or other properties. The given entitlement may be associated with one or more actions such as whether the given entitlement can be traded (e.g., sold or given away), can be modified (e.g., decomposed or combined with others), can be copied or cloned, and/or other actions.

A rights set may include a collection of rights, assertions, and/or denials specified by virtual spaces 106 and virtual objects within them to affect usage, transactions, etc. A virtual object’s creator may be the one that declares the rights set for that virtual object as well as rights granted and/or denied by entitlements issued for the object. According to some implementations, there may be a finite number of scenarios during which rights sets are evaluated. For example, upon entering a virtual space 106, attempting to edit a virtual object, during a transaction, and/or other scenarios. A transaction may require evaluation of multiple rights sets associated with the person, virtual object, and/or virtual space 106.

A right may include a core unit of a capability within the metaverse 100 that can be constrained for purposes of usage, travel, transaction, etc. Rights may be asserted to be true within a given context. Rights may be denied to further usage, nesting, transactions, etc.

A user may control representations of themselves (e.g., an avatar or “virtual person”), which may be tied to one or more accounts in a centrally managed system or platform.

A virtual object may include the smallest atomic unit within the metaverse 100. The virtual object may have one or more representations such as a customer texture, a sticker, a premade object (e.g., a chair), an icon (e.g., for a door), and/or other representations. The virtual object may have a name and/or a unique address. The virtual object may have behaviors attached to it that describe how the virtual object works. In some implementations, the virtual object cannot be inhabited by avatars. The virtual object may be bundled and/or combined with other virtual objects to make larger objects. In some implications, a given larger object may be a virtual space 106. In some implementations, the virtual object can be decomposed into smaller virtual objects 106. The virtual object may have a scarcity (e.g., a limited number of copies that exist across the metaverse 100). The virtual object may have resource limits (e.g., a limited number of times the virtual object can be used before it expires or disappears). Scarcity and/or resource limits may be enforced through a rights set.

According to some implementations, a virtual object may be configured to mint, create, produce, and/or otherwise bring into existence other virtual objects. For example, a printing press may mint or create copies of a digital tee shirt from a template. The virtual object may be instance-based in that it can be pointed to and has an addressable link separate from its template. A virtual object’s lineage from creation to current state may be inspected in some implementations.

Virtual spaces 106 may be navigated by avatars either directly through walking or through teleportation. Individual virtual spaces 106 may have a boundary within which its community guideline sets apply. When travelling between virtual spaces 106, a user/avatar may need to evaluate the rights sets asserted by a target virtual space 106. Teleportation into a nested virtual space 106 may cross multiple boundaries and, as such, the different rights sets may be collapsed as part of an evaluation.

Acts of linking, nesting, and/or merging spaces may include intention acts taken by owners of individual virtual spaces 106. Community guidelines and/or standards, travel, and/or economic considerations may act as motivation for why virtual space owners decide to build a relationship between spaces, and without such motivations, spaces may likely remain separate. For example, user A and user B may each occupy their own virtual spaces 106 (e.g., space A and space B). When space A and space B are initially created, these rooms may be separate in that no direct link between space A and space B exists. After user A and user B become friends, they may desire to quickly access each other’s room. To accomplish this, they may create a link between space A and space B, such that user A can quickly travel to space B, and vice versa.

Two or more virtual spaces 106 may be linked together (e.g., “space A” linked to “space B”). Community guidelines and/or standards considerations may include whether space A owns how the link is rendered but has no say in how space B itself is managed. Travel considerations may include whether traveling from space A to space B is “walking through a portal” or “getting on an airplane” or another mode of travel with clear expectations that the avatar is entering a new virtual space with new community guidelines. Economic considerations may include whether an owner of space B may pay an owner of space A to add a portal or whether an owner of space B may pay an owner of space A a referral fee.

Two or more virtual spaces 106 may be nested relative to each other (e.g., “space B” nested within “space A”). For example, space B may be user B’s room within space A, which may be a house belonging to user A. Community guidelines and/or standards considerations may include whether space B inherits and/or overrides community guidelines from space A. The ability to nest may be restricted based on what community guidelines are declared by space A and space B. Space A may have a copy of space B, although if different copies of space B all share the same community guidelines they may be combined into a common instance. For example, a space C may nest space B and depending on how the community guidelines are set up could share space B with space A. Travel considerations may include whether traveling from space A to space B is “walking through a door” or another mode of transport. The user may see a sign that there are some additional community guidelines in space B (e.g., you must be 21 years or older to enter a bar) but it is still clear to the user that they are still in space A. Economic considerations may include whether an agreement between an owner of space A and an owner of space B decides revenue sharing and/or income. For example, space B may be renting from space A, space A may be franchising from space B, space A may charge space B sales tax, etc.

Two or more virtual spaces 106 may be merged (e.g., “space A” merged with “space B” into a single virtual space). Community guidelines and/or standards considerations may include terms of the merger along with which community guidelines would apply to the merged space, which may require virtual space owners’ agreement. In merged virtual spaces, there may be no notion of traveling between spaces. Instead, it may be clear to users that they are traveling within a single space. Economic considerations may include whether spaces A and/or B may be treated like assets in an asset marketplace. For example, space A may be a virtual store that sells virtual clothing owned and operated by a first entity, and space B may be a virtual personal stylist, who may be a second entity. The virtual store may merge with the personal stylist such that a user may be able to hire the virtual personal stylist to buy virtual clothes at the virtual store. Although these were two virtual spaces, the merger of the two spaces, the user has no notion of traveling between the virtual personal stylist and the virtual store.

Some embodiments may include a catalog service configured to create listings of items for sale. The core functionality may include ingestion of digital goods, distribution, content review workflows, pricing and promotions as well as integration with the payments system. Some embodiments may be configured to track all goods and services a user has purchased and their related entitlements. Purchases the user has made may be validated and/or shared with one or more virtual worlds 104 and/or across a family of applications associated with a virtual universe 102. The user’s purchases may be shareable with third-party services via proprietary and/or interoperable mechanisms (e.g., non-fungible tokens or NFTs).

Beyond the virtual universes 102, virtual worlds 104, and virtual spaces 106, the metaverse 100 may include one or more of user generated content (UGC) and world building capabilities 108; metaverse applications 110; universe-spanning metaverse application 112; virtual world services, avatars, and software developer kits (SDKs) 114; interoperable protocols and formats 116; device operating system (OS), cloud infrastructure, and core technology 118; and/or other components.

The disclosed system(s) address a problem in traditional metaverse, virtual universe, and/or virtual world providing techniques tied to computer technology, namely, the technical problem of facilitating community guidelines and/or standards on how virtual objects/spaces/worlds are used, modified, and/or transacted within a metaverse, e.g., for virtual objects within virtual spaces, virtual spaces within virtual worlds, and virtual worlds within virtual universes. The disclosed system solves this technical problem by providing a solution also rooted in computer technology, namely, by providing for generating a virtual world in a virtual universe. The disclosed subject technology further provides improvements to the functioning of the computer itself because it improves processing and efficiency in providing access to an existing metaverse and/or its constituent virtual universes and/or virtual worlds.

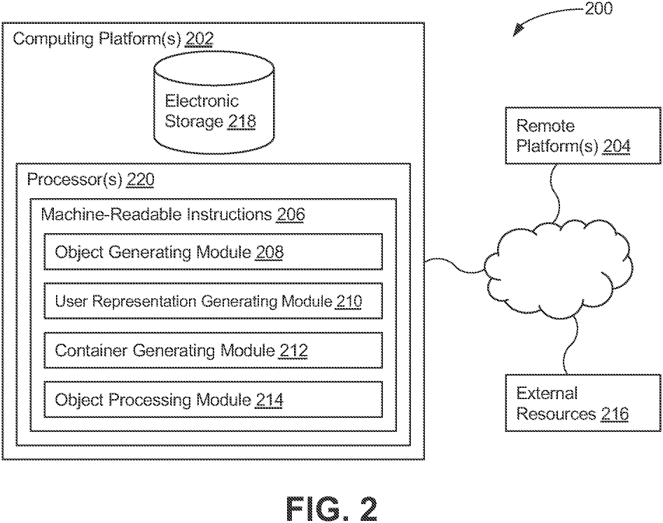

FIG. 2 illustrates a system 200 configured for providing a metaverse and/or its constituent virtual universes and/or virtual worlds, according to certain aspects of the disclosure. In some implementations, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of object generating module 208, user representation generating module 210, container generating module 212, object processing module 214, and/or other instruction modules.

Object generating module 208 may be configured to generate virtual objects including object representations in a virtual world of a virtual universe. The virtual universe may be one of multiple virtual universes included in a common metaverse. The metaverse may include a collection of virtual universes connected via interoperable protocols and/or formats. By way of non-limiting example, the virtual universe may include a system and/or platform associated with a single entity or organization (e.g., a company). For example, a first virtual universe may be owned and operated by a first entity, and a second virtual universe may be owned and operated by a second entity. Users, via their avatars, may buy virtual objects in the first virtual universe and may be able to take those objects into the second virtual universe.

The virtual universe may include one or more virtual worlds. In some implementations, by way of non-limiting example, a given virtual world may include a computer-simulated three-dimensional environment populated by avatars of many users that can simultaneously and independently explore the given virtual world, participate in virtual activities, and communicate with other users. In some implementations, the given virtual world may be focused on social connection.

By way of non-limiting example, a given object representation may include one or more of custom textures, stickers, premade objects, and/or icons. In some implementations, a given virtual object may include a name and a unique address. A given virtual object may have an associated behavior describing how the given virtual object and/or object representation works. A given virtual object may have scarcity in that only a limited number of similar and/or identical virtual objects exist in the virtual universe and/or virtual world. By way of non-limiting example, a given virtual object may have a resource limit such that the given virtual object can only be used, modified, and/or transacted before the given virtual object expires and/or disappears.

In some implementations, a given virtual object cannot be inhabited by avatars. A given virtual object may be configured to be bundled with one or more other virtual objects to create a larger virtual object. In some implementations, the larger virtual object may be inhabited by avatars (e.g., spatial containers). One or more virtual objects may be configured to mint other objects. Minting a virtual object may include one or more of creating, producing, and/or otherwisGe bringing into existence.

User representation generating module 210 may be configured to generate avatars including user representations of themselves in the virtual world. In some implementations, a given avatar may be associated with a specific user account in a centrally managed system. By way of non-limiting example, the user representation may include one or more of a textual representation, a graphical representation, and/or a live video avatar. In some implementations, the user representation may include one or both of an auditory sensation and/or a touch sensation.

Container generating module 212 may be configured to generate spatial containers within the virtual world. The spatial containers may include multiple virtual objects. A given spatial container may be configured to be inhabited by avatars. A given spatial container may represent a smallest unit of interactive experience that can be built within a given virtual world.

By way of non-limiting example, an owner of the given spatial container may manage one or more of access, personal expression, and/or social norms. Managing access may include administering community guidelines and/or standards as to which avatars are allowed to enter the given spatial container. Managing personal expression may include administering community guidelines and/or standards as to what avatar representations are allowed within the given spatial container. Managing social norms may include administering community guidelines and/or standards as to what avatar behaviors are allowed within the given spatial container. A given spatial container may have an associated membership such that an avatar can belong to the given spatial container. Belonging to the given spatial container may include being granted with additional privileges relative to non-members. For example, a spatial container may be a virtual hotel, where users can enter, stay as guests, and enjoy hotel amenities. Community guidelines and/or standards in the virtual hotel may dictate that users’ avatars must be dressed appropriately and may restrict access to only those users who are guests of the virtual hotel. For the rooms, there may be further guidelines (e.g., a given room is for conferences while another room is for sleeping). Community guidelines may also specify that users are allowed to communicate with each other but are not allowed to use profanity or degrading language with each other.

Object processing module 214 may be configured to process transactions regarding the virtual objects between the avatars based on evaluations of rights sets associated with the virtual objects. By way of non-limiting example, a given transaction may include selling, trading, transferring, and/or licensing virtual objects and/or spatial containers . By way of non-limiting example, a given rights set includes limited units an ability to use, modify, and/or transact a virtual object and/or spatial container. By way of non-limiting example, a given right may include a limited unit of an ability to use, modify, and/or transact the virtual object and/or spatial container.

In some implementations, computing platform(s) 202, remote platform(s) 204, and/or external resources 216 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 216 may be operatively linked via some other communication media.

A given remote platform 204 may include one or more processors configured to execute computer program modules. The computer program modules may be configured to enable an expert or user associated with the given remote platform 204 to interface with system 200 and/or external resources 216, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 216 may include sources of information outside of system 200, external entities participating with system 200, and/or other resources. In some implementations, some or all of the functionality attributed herein to external resources 216 may be provided by resources included in system 200.

Computing platform(s) 202 may include electronic storage 218, one or more processors 220, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 218 may comprise non-transitory storage media that electronically stores information. The electronic storage media of electronic storage 218 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 218 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 218 may include one or more virtual storage resources (e.g., cloud storage, a virtual private network, and/or other virtual storage resources). Electronic storage 218 may store software algorithms, information determined by processor(s) 220, information received from computing platform(s) 202, information received from remote platform(s) 204, and/or other information that enables computing platform(s) 202 to function as described herein.

Processor(s) 220 may be configured to provide information processing capabilities in computing platform(s) 202. As such, processor(s) 220 may include one or more of a digital processor, an analog processor, a digital circuit designed to process information, an analog circuit designed to process information, a state machine, and/or other mechanisms for electronically processing information. Although processor(s) 220 is shown in FIG. 2 as a single entity, this is for illustrative purposes only. In some implementations, processor(s) 220 may include a plurality of processing units. These processing units may be physically located within the same device, or processor(s) 220 may represent processing functionality of a plurality of devices operating in coordination. Processor(s) 220 may be configured to execute modules 208, 210, 212, and/or 214, and/or other modules. Processor(s) 220 may be configured to execute modules 208, 210, 212, and/or 214, and/or other modules by software; hardware; firmware; some combination of software, hardware, and/or firmware; and/or other mechanisms for configuring processing capabilities on processor(s) 220. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, and/or 214 are illustrated in FIG. 2 as being implemented within a single processing unit, in implementations in which processor(s) 220 includes multiple processing units, one or more of modules 208, 210, 212, and/or 214 may be implemented remotely from the other modules. The description of the functionality provided by the different modules 208, 210, 212, and/or 214 described below is for illustrative purposes, and is not intended to be limiting, as any of modules 208, 210, 212, and/or 214 may provide more or less functionality than is described. For example, one or more of modules 208, 210, 212, and/or 214 may be eliminated, and some or all of its functionality may be provided by other ones of modules 208, 210, 212, and/or 214. As another example, processor(s) 220 may be configured to execute one or more additional modules that may perform some or all of the functionality attributed below to one of modules 208, 210, 212, and/or 214.

In particular embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular embodiments, privacy settings may be based on one or more nodes or edges of a social graph. A privacy setting may be specified for one or more edges or edge-types of the social graph, or with respect to one or more nodes, or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system. The object may be associated with a concept node connected to a user node of the first user by an edge. The first user may specify privacy settings that apply to a particular edge connecting to the concept node of the object, or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user’s current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers may be authorization/privacy servers for enforcing privacy settings. In response to a request from a user (or other entity) for a particular object stored in a data store, the social-networking system may send a request to the data store for the object. The request may identify the user associated with the request and the object may be sent only to the user (or a client system of the user) if the authorization server determines that the user is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user’s “Trending” page. In particular embodiments, an object may correspond to a particular user. The object may be content associated with the particular user, or may be the particular user’s account or information stored on the social-networking system, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user’s status updates are public, but any images shared by the first user are visible only to the first user’s friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user’s employer. In particular embodiments, different privacy settings may be provided for different user groups or user demographics. As an example and not by way of limitation, a first user may specify that other users who attend the same university as the first user may view the first user’s pictures, but that other users who are family members of the first user may not view those same pictures.

In particular embodiments, the social-networking system may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system may access such information in order to provide a particular function or service to the first user, without the social-networking system having access to that information for any other purposes. Before accessing, storing, or using such objects or information, the social-networking system may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system.

In particular embodiments, a user may specify whether particular types of objects or information associated with the first user may be accessed, stored, or used by the social-networking system. As an example and not by way of limitation, the first user may specify that images sent by the first user through the social-networking system may not be stored by the social-networking system. As another example and not by way of limitation, a first user may specify that messages sent from the first user to a particular second user may not be stored by the social-networking system. As yet another example and not by way of limitation, a first user may specify that all objects sent via a particular application may be saved by the social-networking system.

In particular embodiments, privacy settings may allow a first user to specify whether particular objects or information associated with the first user may be accessed from particular client systems or third-party systems. The privacy settings may allow the first user to opt in or opt out of having objects or information accessed from a particular device (e.g., the phone book on a user’s smart phone), from a particular application (e.g., a messaging app), or from a particular system (e.g., an email server). The social-networking system may provide default privacy settings with respect to each device, system, or application, and/or the first user may be prompted to specify a particular privacy setting for each context. As an example and not by way of limitation, the first user may utilize a location-services feature of the social-networking system to provide recommendations for restaurants or other places in proximity to the user. The first user’s default privacy settings may specify that the social-networking system may use location information provided from a client device of the first user to provide the location-based services, but that the social-networking system may not store the location information of the first user or provide it to any third-party system. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The social-networking system may determine that this privacy setting also applies to the first image and make the first image visible only to the first user group. In particular embodiments, the change in privacy settings may take effect only going forward. Continuing the example above, if the first user changes privacy settings and then shares a second image, the second image may be visible only to the first user group, but the first image may remain visible to all users. In particular embodiments, in response to a user action to change a privacy setting, the social-networking system may further prompt the user to indicate whether the user wants to apply the changes to the privacy setting retroactively. In particular embodiments, a user change to privacy settings may be a one-off change specific to one object. In particular embodiments, a user change to privacy may be a global change for all objects associated with the user.

In particular embodiments, the social-networking system may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular embodiments, upon determining that a trigger action has occurred, the social-networking system may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular embodiments, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user’s default privacy settings may indicate that a person’s relationship status is visible to all users (i.e., “public”). However, if the user changes his or her relationship status, the social-networking system may determine that such action may be sensitive and may prompt the user to confirm that his or her relationship status should remain public before proceeding. As another example and not by way of limitation, a user’s privacy settings may specify that the user’s posts are visible only to friends of the user. However, if the user changes the privacy setting for his or her posts to being public, the social-networking system may prompt the user with a reminder of the user’s current privacy settings of posts being visible only to friends, and a warning that this change will make all of the user’s past posts visible to the public. The user may then be required to provide a second verification, input authentication credentials, or provide other types of verification before proceeding with the change in privacy settings. In particular embodiments, a user may need to provide verification of a privacy setting on a periodic basis. A prompt or reminder may be periodically sent to the user based either on time elapsed or a number of user actions. As an example and not by way of limitation, the social-networking system may send a reminder to the user to confirm his or her privacy settings every six months or after every ten photo posts. In particular embodiments, privacy settings may also allow users to control access to the objects or information on a per-request basis. As an example and not by way of limitation, the social-networking system may notify the user whenever a third-party system attempts to access information associated with the user, and require the user to provide verification that access should be allowed before proceeding.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

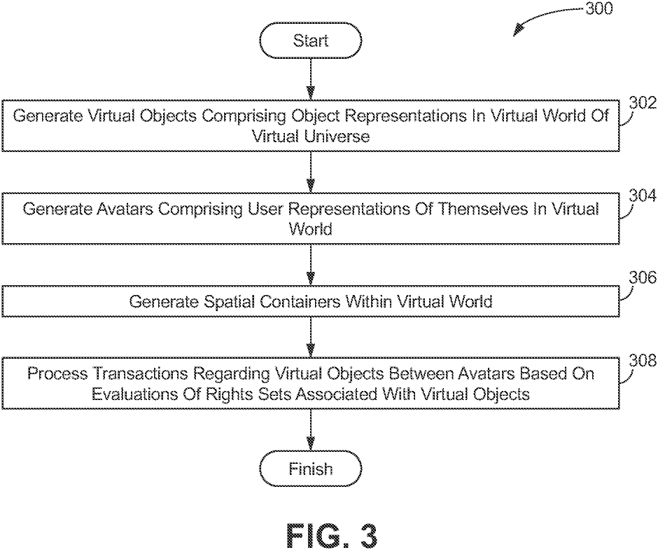

FIG. 3 illustrates an example flow diagram (e.g., process 300) for generating a virtual world in a virtual universe, according to certain aspects of the disclosure. For explanatory purposes, the example process 300 is described herein with reference to FIGS. 1-2. Further for explanatory purposes, the steps of the example process 300 are described herein as occurring in serial, or linearly. However, multiple instances of the example process 300 may occur in parallel. For purposes of explanation of the subject technology, the process 300 will be discussed in reference to FIGS. 1-2.

At step 302, the process 300 may include generating virtual objects including object representations in a virtual world of a virtual universe. At step 304, the process 300 may include generating avatars including user representations of themselves in the virtual world. At step 306, the process 300 may include generating spatial containers within the virtual world. At step 308, the process 300 may include processing transactions regarding the virtual objects between the avatars based on evaluations of rights sets associated with the virtual objects.

For example, as described above in relation to FIGS. 1-2, at step 302, the process 300 may include generating virtual objects including object representations in a virtual world of a virtual universe, through object generating module 208. At step 304, the process 300 may include generating avatars including user representations of themselves in the virtual world, through user representation generating module 210. At step 306, the process 300 may include generating spatial containers within the virtual world, through container generating module 212. At step 308, the process 300 may include processing transactions regarding the virtual objects between the avatars based on evaluations of rights sets associated with the virtual objects, through object processing module 214.

According to an aspect, the virtual universe is one of multiple virtual universes included in a common metaverse. According to an aspect, the metaverse includes a collection of virtual universes connected via interoperable protocols and/or formats. According to an aspect, the virtual universe includes a system and/or platform associated with a single entity or organization (e.g., a company).

According to an aspect, the virtual universe comprises one or more virtual worlds. According to an aspect, a given virtual world includes a computer-simulated three-dimensional environment populated by avatars of many users that can simultaneously and independently explore the given virtual world, participate in virtual activities, and communicate with other users. According to an aspect, the given virtual world is focused on social connection.

According to an aspect, a given virtual object includes a name and a unique address. According to an aspect, a given virtual object has an associated behavior describing how the given virtual object works. According to an aspect, a given virtual object cannot be inhabited by avatars. According to an aspect, a given virtual object is configured to be bundled with one or more other virtual objects to create a larger virtual object. According to an aspect, a given virtual object has scarcity in that only a limited number of similar and/or identical virtual objects exist in the virtual universe and/or virtual world. According to an aspect, a given virtual object has a resource limit such that the given virtual object can only be used, modified, and/or transacted before the given virtual object expires and/or disappears. According to an aspect, a given object representation includes one or more of custom textures, stickers, premade objects, and/or icons.

According to an aspect, a given avatar is associated with a specific user account in a centrally managed system.

According to an aspect, the user representation includes one or more of a textual representation, a graphical representation, and/or a live video avatar. According to an aspect, the user representation includes one or both of an auditory sensation and/or a touch sensation.

According to an aspect, the spatial containers comprise multiple virtual objects. According to an aspect, a given spatial container is configured to be inhabited by avatars. According to an aspect, an owner of the given spatial container manages one or more of access, personal expression, and/or social norms. According to an aspect, a given spatial container represents a smallest unit of interactive experience that can be built within a given virtual world. According to an aspect, a given spatial container has an associated membership such that an avatar can belong to the given spatial container. According to an aspect, belonging to the given spatial container includes being granted with additional privileges relative to non-members.

According to an aspect, one or more virtual objects are configured to mint other objects.

According to an aspect, a given transaction includes selling, trading, transferring, and/or licensing virtual objects and/or spatial containers.

According to an aspect, a given rights set comprises limited units of an ability to use, modify, and/or transact a virtual object. According to an aspect the given rights set comprises a collection of rights, assertions, and/or denials specified by virtual worlds and virtual objects within them affecting usage and/or transactions

According to an aspect, a given right includes a unit of the ability to use, modify, and/or transact the virtual object.

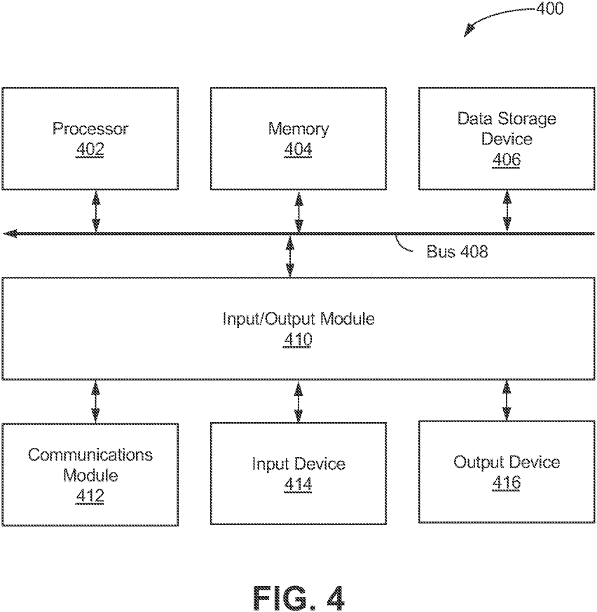

FIG. 4 is a block diagram illustrating an exemplary computer system 400 with which aspects of the subject technology can be implemented. In certain aspects, the computer system 400 may be implemented using hardware or a combination of software and hardware, either in a dedicated server, integrated into another entity, or distributed across multiple entities.

Computer system 400 (e.g., server and/or client) includes a bus 408 or other communication mechanism for communicating information, and a processor 402 coupled with bus 408 for processing information. By way of example, the computer system 400 may be implemented with one or more processors 402. Processor 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 400 can include, in addition to hardware, code that creates an execution environment for the computer program in question, e.g., code that constitutes processor firmware, a protocol stack, a database management system, an operating system, or a combination of one or more of them stored in an included memory 404, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The processor 402 and the memory 404 can be supplemented by, or incorporated in, special purpose logic circuitry.

The instructions may be stored in the memory 404 and implemented in one or more computer program products, i.e., one or more modules of computer program instructions encoded on a computer-readable medium for execution by, or to control the operation of, the computer system 400, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 404 may also be used for storing temporary variable or other intermediate information during execution of instructions to be executed by processor 402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 400 further includes a data storage device 406 such as a magnetic disk or optical disk, coupled to bus 408 for storing information and instructions. Computer system 400 may be coupled via input/output module 410 to various devices. The input/output module 410 can be any input/output module. Exemplary input/output modules 410 include data ports such as USB ports. The input/output module 410 is configured to connect to a communications module 412. Exemplary communications modules 412 include networking interface cards, such as Ethernet cards and modems. In certain aspects, the input/output module 410 is configured to connect to a plurality of devices, such as an input device 414 and/or an output device 416. Exemplary input devices 414 include a keyboard and a pointing device, e.g., a mouse or a trackball, by which a user can provide input to the computer system 400. Other kinds of input devices 414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 416 include display devices such as an LCD (liquid crystal display) monitor, for displaying information to the user.

According to one aspect of the present disclosure, the above-described gaming systems can be implemented using a computer system 400 in response to processor 402 executing one or more sequences of one or more instructions contained in memory 404. Such instructions may be read into memory 404 from another machine-readable medium, such as data storage device 406. Execution of the sequences of instructions contained in the main memory 404 causes processor 402 to perform the process steps described herein. One or more processors in a multi-processing arrangement may also be employed to execute the sequences of instructions contained in memory 404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 400 can include clients and servers. A client and server are generally remote from each other and typically interact through a communication network. The relationship of client and server arises by virtue of computer programs running on the respective computers and having a client-server relationship to each other. Computer system 400 can be, for example, and without limitation, a desktop computer, laptop computer, or tablet computer. Computer system 400 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 402 for execution. Such a medium may take many forms, including, but not limited to, non-volatile media, volatile media, and transmission media. Non-volatile media include, for example, optical or magnetic disks, such as data storage device 406. Volatile media include dynamic memory, such as memory 404. Transmission media include coaxial cables, copper wire, and fiber optics, including the wires that comprise bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 400 reads game data and provides a game, information may be read from the game data and stored in a memory device, such as the memory 404. Additionally, data from the memory 404 servers accessed via a network the bus 408, or the data storage 406 may be read and loaded into the memory 404. Although data is described as being found in the memory 404, it will be understood that data does not have to be stored in the memory 404 and may be stored in other memory accessible to the processor 402 or distributed among several media, such as the data storage 406.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for generating a virtual world in a virtual universe, comprising:
generating virtual objects comprising object representations in a virtual world of a virtual universe;
generating avatars comprising user representations of themselves in the virtual world;
generating spatial containers within the virtual world; and
processing transactions regarding the virtual objects between the avatars based on evaluations of rights sets associated with the virtual objects, wherein a given rights set comprises limited units of an ability to use, modify, and/or transact a virtual object.

2. The method of claim 1, wherein the spatial containers comprise multiple virtual objects.

3. The method of claim 1, wherein a given object representation includes one or more of custom textures, stickers, premade objects, and/or icons.

4. The method of claim 1, wherein one or more virtual objects are configured to mint other objects.

5. The method of claim 1, wherein the virtual universe comprises one or more virtual worlds.

6. The method of claim 1, wherein a given avatar is associated with a specific user account in a centrally managed system.

7. The method of claim 1, wherein the given rights set comprises a collection of rights, assertions, and/or denials specified by virtual worlds and virtual objects within them to affect usage and/or transactions.

8. The method of claim 1, wherein the virtual universe is one of multiple virtual universes included in a common metaverse, wherein the metaverse includes a collection of virtual universes connected via interoperable protocols and/or formats, and wherein the virtual universe includes a system and/or platform associated with a single entity or organization.

9. The method of claim 1, wherein a given virtual world includes a computer-simulated three-dimensional environment populated by avatars of many users that can simultaneously and independently explore the given virtual world, participate in virtual activities, and communicate with other users.

10. The method of claim 9, wherein the given virtual world is focused on social connection.

11. A system configured for generating a virtual world in a virtual universe, the system comprising:
one or more hardware processors configured by machine-readable instructions to:
generate virtual objects comprising object representations in a virtual world of a virtual universe;
generate avatars comprising user representations of themselves in the virtual world, wherein a given avatar is associated with a specific user account in a centrally managed system;
generate spatial containers within the virtual world, wherein the spatial containers comprise multiple virtual objects; and
process transactions regarding the virtual objects between the avatars based on evaluations of rights sets associated with the virtual objects, wherein a given rights set comprises limited units of an ability to use, modify, and/or transact a virtual object.

12. The system of claim 11, wherein an owner of the given spatial container manages one or more of access, personal expression, and/or social norms.

13. The system of claim 12, wherein managing access includes administering community guidelines and/or standards as to which avatars are allowed to enter the given spatial container.

14. The system of claim 12, wherein managing personal expression includes administering community guidelines and/or standards as to what avatar representations are allowed within the given spatial container.

15. The system of claim 12, wherein managing social norms includes administering community guidelines and/or standards as to what avatar behaviors are allowed within the given spatial container.

16. The system of claim 11, wherein a given spatial container has an associated membership such that an avatar can belong to the given spatial container.

17. The system of claim 16, wherein belonging to the given spatial container includes being granted with additional privileges relative to non-members.

18. The system of claim 11, wherein a given transaction includes selling, trading, transferring, and/or licensing virtual objects and/or spatial containers.

19. The system of claim 11, wherein the user representation includes one or more of a textual representation, a graphical representation, and/or a live video avatar.

20. A non-transient computer-readable storage medium having instructions embodied thereon, the instructions being executable by one or more processors to perform a method for generating a virtual world in a virtual universe, the method comprising:
generating virtual objects comprising object representations in a virtual world of a virtual universe, wherein a given virtual object cannot be inhabited by avatars;
generating avatars comprising user representations of themselves in the virtual world, wherein a given avatar is associated with a specific user account in a centrally managed system;
generating spatial containers within the virtual world, wherein the spatial containers comprise multiple virtual objects, and wherein a given spatial container can be inhabited by avatars; and
processing transactions regarding the virtual objects between the avatars based on evaluations of rights sets associated with the virtual objects, wherein a given rights set comprises limited units of an ability to use, modify, and/or transact a virtual object.
